(19) United States
(12) Patent Application Publication
(10) Pub. No.: US 2022/0219788 A1
(43) Pub. Date: Jul. 14, 2022

(54) TRANSPORT VEHICLE WITH REDUCED DRAG

(71) Applicant: PAHA DESIGNS, LLC, Felt, ID (US)

(72) Inventor: Benjamin Meager, Felt, ID (US)

(21) Appl. No.: 17/608,244

(22) PCT Filed: Apr. 29, 2020
(86) PCT No.: PCT/US2020/030497

§ 371 Date: Nov. 2, 2021

Related U.S. Application Data
(60) Provisional application No. 62/849,238, filed on May 17, 2019.
(60) Provisional application No. 62/843,208, filed on May 3, 2019.

(51) Int. Cl. B63B 1/38; B62D 35/00; B64C 21/10

(52) U.S. Cl. CPC B63B 1/38; B64C 21/10; B62D 35/00

(57) ABSTRACT

A number of different vehicle configurations are disclosed. An illustrative vehicle is disclosed to include a solid surfaced body having a front end, a propulsion unit that applies a propulsion force to the body and causes the front end to travel toward a traveling medium in a direction of travel, and at least one output port that is positioned on the body in such a way that fluid expelled from the at least one output port is expelled in a direction opposite to the propulsion force, wherein the fluid expelled from the at least one output port is expelled at a rate that is at least one order of magnitude less than a rate at which fluid is displaced by the propulsion unit.

### CROSS REFERENCE TO RELATED APPLICATIONS

The present application claims the benefit under 35 U.S.C. § 119(e) of U.S. Provisional Application Nos. 62/849,238, filed on May 17, 2019, and 62/843,208, filed on May 3, 2019, the entire disclosures of each of which are hereby incorporated herein by reference.

### FIELD

The present disclosure relates generally to the field of transportation and, in particular, toward vehicles used in transportation with reduced drag capabilities.

### SUMMARY

In fluid dynamics, drag is a force acting opposite to the relative motion of an object moving with respect to the surrounding fluid or gas. Drag can exist between two fluid layers (e.g., liquid or gas) or between a fluid and a solid surface of an object. To the extent that drag forces can be reduced for a vehicle moving through a fluid, the amount of force required to propel the vehicle through the fluid can be reduced. The reduction of drag forces almost always results in improved fuel efficiency or speed of travel for a vehicle.

### BRIEF DESCRIPTION OF THE DRAWINGS

The present disclosure is described in conjunction with the appended figures, which are not necessarily drawn to scale.

FIG. 1A depicts a front view of a first vehicle;

FIG. 1B depicts an isometric view of the first vehicle;

FIG. 2A depicts an isometric view of a first vehicle according to embodiments of the present disclosure;

FIG. 2B depicts the first vehicle with additional output ports according to embodiments of the present disclosure;

FIG. 3A depicts additional details of the first vehicle according to embodiments of the present disclosure;

FIG. 3B depicts a side view of the first vehicle depicted in FIG. 3A;

FIG. 4A depicts a bottom isometric view of a second vehicle;

FIG. 4B depicts a bottom isometric view of a second vehicle according to embodiments of the present disclosure;

FIG. 4C depicts additional details of the second vehicle depicted in FIG. 4B;

FIG. 4D depicts the second vehicle with additional output ports according to embodiments of the present disclosure;

FIG. 4E depicts additional details of the second vehicle depicted in FIG. 4D;

FIG. 4F depicts an alternative configuration of the second vehicle according to embodiments of the present disclosure;

FIG. 4G depicts a cross-sectional view of a vehicle body according to embodiments of the present disclosure;

FIG. 5A depicts a side view of a third vehicle according to embodiments of the present disclosure;

FIG. 5B depicts a side view of a third vehicle according to embodiments of the present disclosure;

FIG. 5C depicts a simplified cross-sectional view of the third vehicle according to embodiments of the present disclosure;

FIG. 6A depicts a side view of a fourth vehicle;

FIG. 6B depicts a side view of the fourth vehicle according to embodiments of the present disclosure;

FIG. 6C depicts a simplified cross-sectional view of the fourth vehicle according to embodiments of the present disclosure;

FIG. 6D depicts additional details of the fourth vehicle according to embodiments of the present disclosure;

FIG. 6E depicts additional details of the fourth vehicle according to embodiments of the present disclosure;

FIG. 7A depicts additional details of the fourth vehicle according to embodiments of the present disclosure;

FIG. 7B is an exploded view of a portion of FIG. 7A; and

FIG. 8 depicts additional details of a wing in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. Various changes may be made in the function and arrangement of elements without departing from the spirit and scope of the appended claims.

Embodiments of the present disclosure will be described in connection with illustrative vehicles, which may or may not be configured to carry passengers as cargo. As used herein, the term “vehicle” may include any solid object that travels through a fluid (e.g., gas or liquid). A vehicle may or may not require some amount of propulsion to travel through the fluid. A vehicle travelling through the fluid may displace the fluid. It should be appreciated that by displacing fluid during travel, the vehicle may experience one or more drag forces at points where the fluid contact a solid surface of the vehicle (or at points where the solid surface of the vehicle contacts the fluid). Embodiments of the present disclosure propose mechanisms for reducing drag-induced forces that are presented to the vehicle by outputting one or more fluids in a way that effectively breaks the fluid through which the vehicle is traveling. Said another way, and in accordance with embodiments described herein, the vehicle may be equipped with one or more mechanisms that cause fluid to be expelled in front of or across a solid surface of the vehicle (e.g., outward from a forward-travelling surface), thereby creating a fluidic barrier between the primary fluid in which the vehicle is traveling (which may also be referred to as the traveling medium) and the solid surface(s) of the vehicle. While drag forces may still exist between the traveling medium and the expelled fluid and also between the expelled fluid and the solid surface(s) of the vehicle, it should be appreciated that such drag forces are reduced as compared to the drag forces that would be experienced by the vehicle in the absence of an expelled fluid being provided in front of or across the solid surface(s) of the vehicle.

As will be described in further detail herein, a vehicle may include one or more of an aircraft, watercraft, and/or land-traveling vehicle. Examples of a land-traveling vehicle include, without limitation, a truck, semi-truck, train, road train, tractor, motorcycle, passenger car, Sports Utility Vehicle (SUV), or the like. Examples of a water-traveling vehicle include a boat, a submarine, a freighter, a cruise ship, etc. Examples of an air-traveling vehicle include a plane, a rocket, a drone, etc.

Embodiments of the present disclosure contemplate the use of expelled fluid to not only reduce drag, but to also create an environment in front of a traveling vehicle where the traveling medium is disrupted prior to the solid surface of the vehicle impacting the traveling medium. This environment may further benefit travel of the vehicle because one or more vortices are moved away from the solid surface of the vehicle and could be considered to help propel the vehicle forward (in addition to other propulsion forces being applied to the vehicle). In other words, the utilization of an expelled fluid at the front of a vehicle may create an environment that is both propelling the vehicle and also exhibiting a reduced drag on the vehicle as compared to the vehicle impacting a still traveling medium.

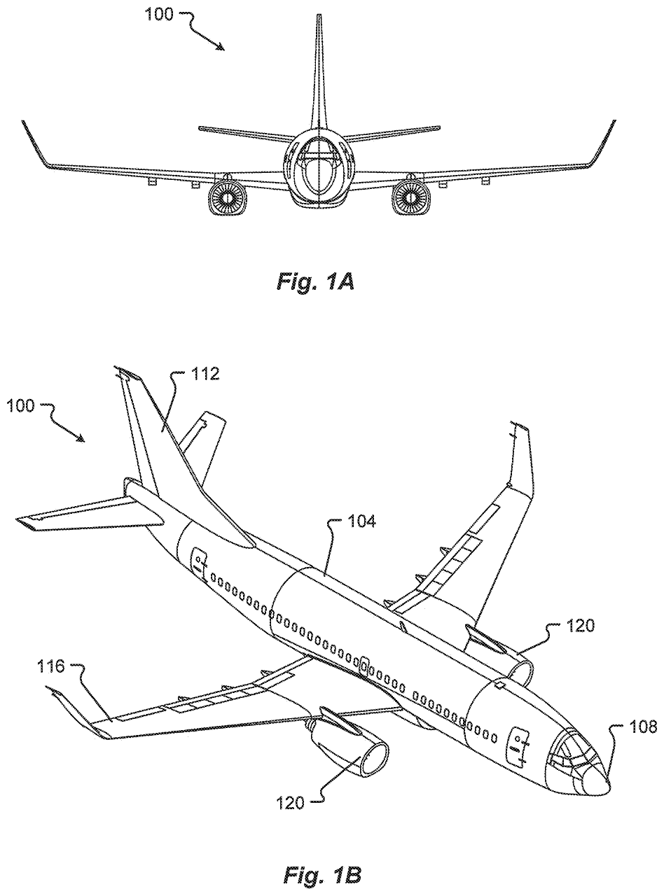

With reference now to FIGS. 1A-3B, a first illustrative vehicle 100 will be described in accordance with embodiments of the present disclosure. The first illustrative vehicle 100 is shown as an aircraft, airplane, jet, or the like that is configured to travel through a traveling medium of gas (e.g., air, the earth's atmosphere, etc.). The vehicle 100 is shown to include a body 104, a front end 108, a tail 112, and wings 116. The vehicle 100 is also shown to include one or more propulsion units 120 that provide a driving force for the vehicle 100. In particular, the vehicle 100 may correspond to a jet in which the propulsion units 120 are jet engines, which provide a jet-based driving force for the vehicle 100. It should be appreciated that other types of propulsion units 120, such as propellers or rocket engines, may be used without departing from the scope of the present disclosure. As propulsion forces are provided by the propulsion units 120, the front end 108 of the vehicle 100 is forced into contact with the traveling medium (e.g., air). Likewise, the leading edges of the wings 116 and tail 112 are also forced into contact with the traveling medium.

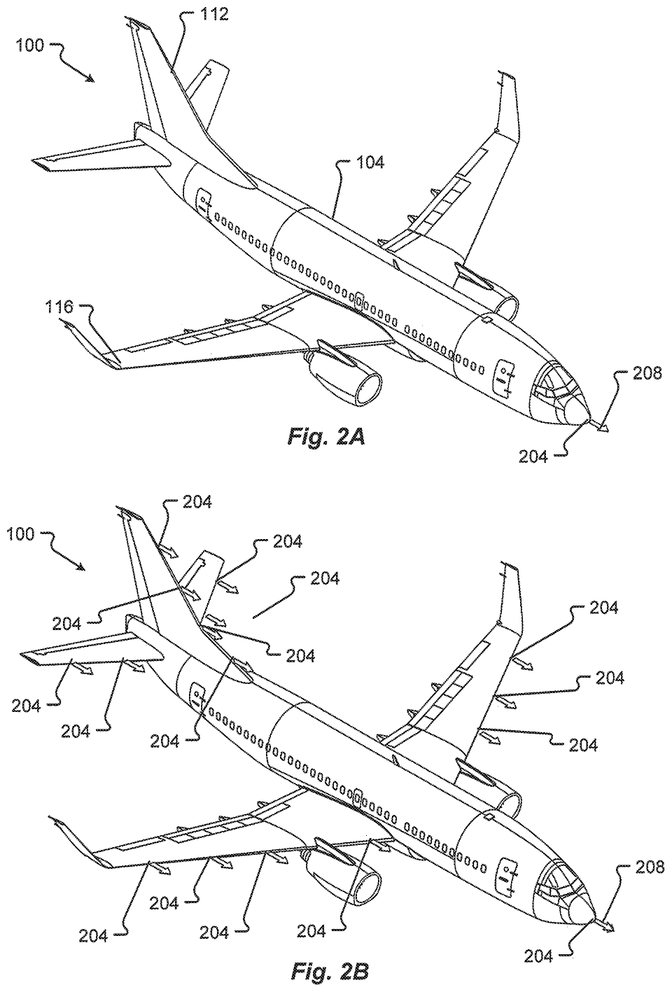

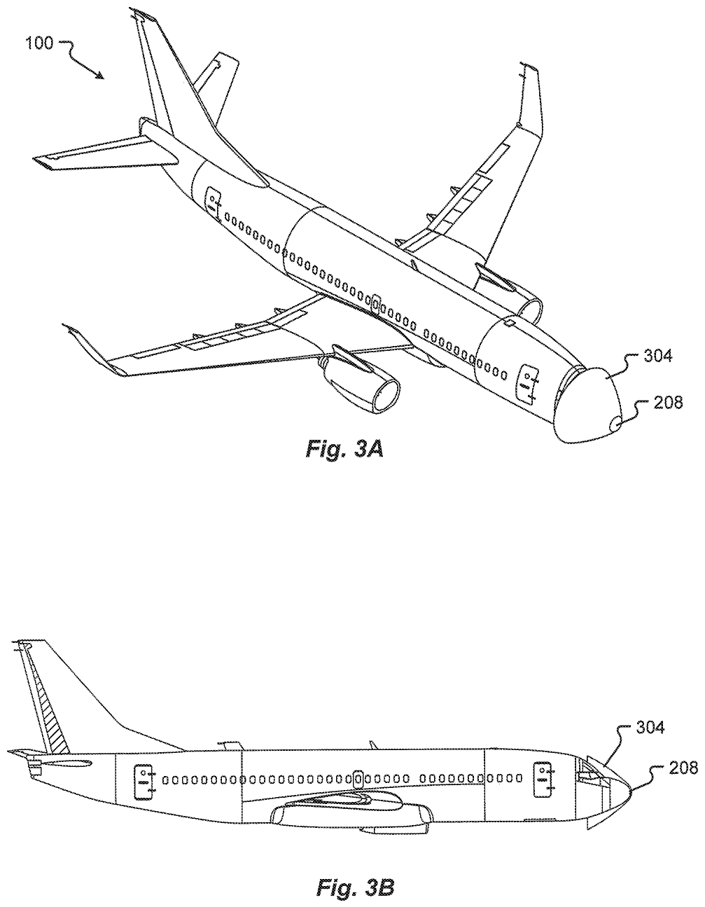

As shown in FIGS. 2A-3B, embodiments of the present disclosure contemplate providing one or more output ports 204 on the front end 108 of the vehicle 100 and/or on leading edges of the tail 112 and wings 116. Alternatively or additionally, a leading edge of a propeller could be configured to include one or more output ports 204 without departing from the scope of the present disclosure. The propeller (or similar propulsion unit 120) could be provided at the front end 108 of the vehicle 100 and/or on the wings 116 of the vehicle 100.

The output port(s) 204 may be configured as an opening, which may or may not have a controllable door provided at the entrance thereto, through which expelled fluid 208 can be provided. In some embodiments, the expelled fluid 208 is pushed out of the output port(s) 204 under a compression force, which may be provided by an air compressor that is housed internally within the body 104 of the vehicle 100. The expelled fluid 208 may correspond to the same fluid as the traveling medium (e.g., air) or the expelled fluid 208 may correspond to a different type of fluid than the traveling medium. As a non-limiting example, the expelled fluid 208 may correspond to pure oxygen or compressed oxygen whereas the traveling medium corresponds to air. In some embodiments, the compressed oxygen may be provided by a compression tank that is maintained for purposes of providing compressed oxygen to the cabin in the body 104 of the vehicle 100. Such compression tanks are already provided for purposes of allowing passengers of the vehicle 100 to breathe while the vehicle 100 is traveling at relatively high altitudes, which means that the already-existing compression tank can be dual-purposed to provide the expelled fluid 208 out of the one or more output ports 204. Alternatively or additionally, some of the expelled fluid 208 may correspond to fluid that is recaptured toward a back of the vehicle. For instance, exhaust of the propulsion unit 120 may be recaptured and converted into expelled fluid 208 without departing from the scope of the present disclosure. Other discarded fluids or contained fluids could also be recaptured and used for expelled fluid 208 alone or in combination with other fluids.

As shown in FIGS. 3A and 3B, the expelled fluid 208 may initially be provided in the same direction as the direction of travel of the vehicle 100. The expelled fluid 208, once outside the output port 204, may come into contact with the traveling medium, thereby causing the expelled fluid 208 to travel a fluid path 304 that surrounds or at least partially envelopes the solid surface of the vehicle 100. The expelled fluid 208 traveling the fluid path 304 may create a fluidic barrier between the traveling medium and the solid surface(s) of the vehicle 100, thereby reducing drag forces imparted on the vehicle 100.

Providing the expelled fluid 208 in the direction of travel may seem counterintuitive because the ejection of the expelled fluid 208 may be seen as counteracting the forces produced by the propulsion unit 120. However, the forces imparted by the expelled fluid 208 may be minimal as compared to the reduction in drag forces enabled by the expelled fluid 208 traveling the fluid path 304. In other words, the reduction in frictional forces traveling may be larger than the amount of backward forces imparted on the vehicle 100 by the expelled fluid 208.

In some embodiments, the expelled fluid 208 is output at a rate which is one or multiple orders of magnitude less than a mass flow rate produced by the propulsion units 120. In some embodiments, the propulsion units 120 may be configured to operate at a mass flow rate of at least 1,300 kg/s where the output ports 204 may output the expelled fluid 208 at a mass flow rate of less than 1 kg/s or 10 kg/s. Thus, the mass flow rate produced at the output ports 204 will not be enough to substantially counteract or provide a backwards propulsion force as compared to the propulsion units 120. However, the output ports 204 may still output enough expelled fluid 208 to effectively break or interrupt the traveling medium before the solid surface of the vehicle 100 impacts the traveling medium, which may be assumed to be substantially motionless with respect to the traveling vehicle 100.

In some embodiments, it may be possible to utilize one or more output ports 204 in connection with modifying or adjusting the lift applied to the vehicle 100 as the vehicle 100 travels through the air. As a non-limiting example, expelled fluid 208 may change the air speed traveling across the top and/or bottom of a wing, thereby changing the lift profile of the wing. It may be possible to precisely control the volume of expelled fluid 208 and the output ports 204 from which the expelled fluid 208 is dispensed in an effort to change the lift applied to the wings 116. It may also be possible to utilize the expelled fluid 208 to steer or change a direction of travel of the vehicle 100. For instance, providing expelled fluid 208 on a left side of the vehicle 100 and not providing as much (or no) expelled fluid 208 on the right side of the vehicle 100 may cause the vehicle 100 to turn left (e.g., toward the side where more expelled fluid 208 is being dispensed). This can be used in addition to traditional rudders and other direction-control devices of a vehicle 100.

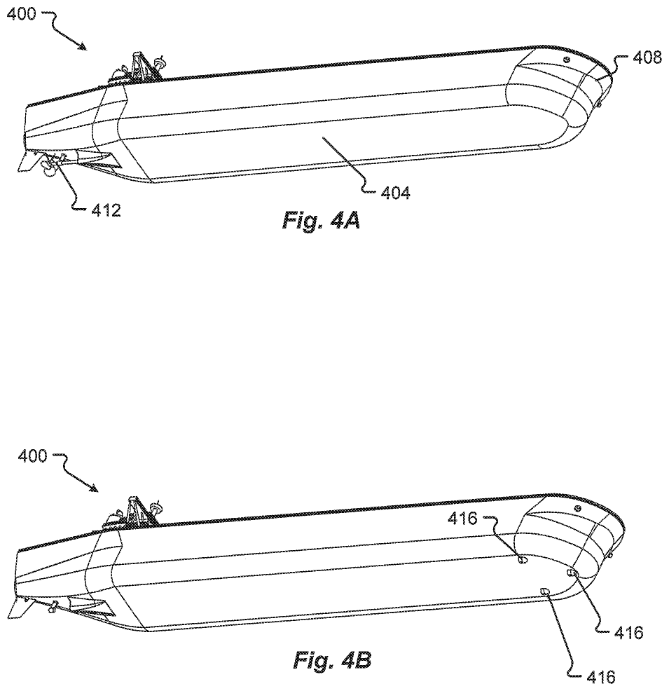

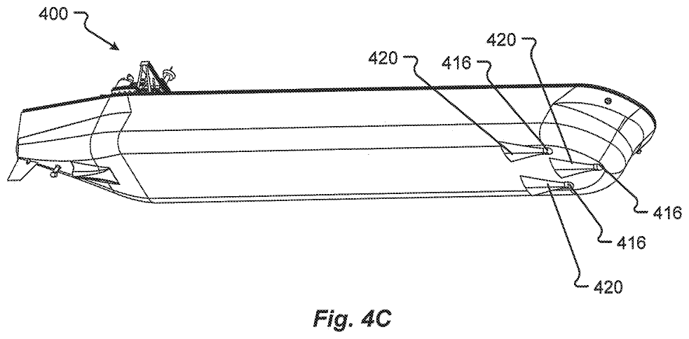

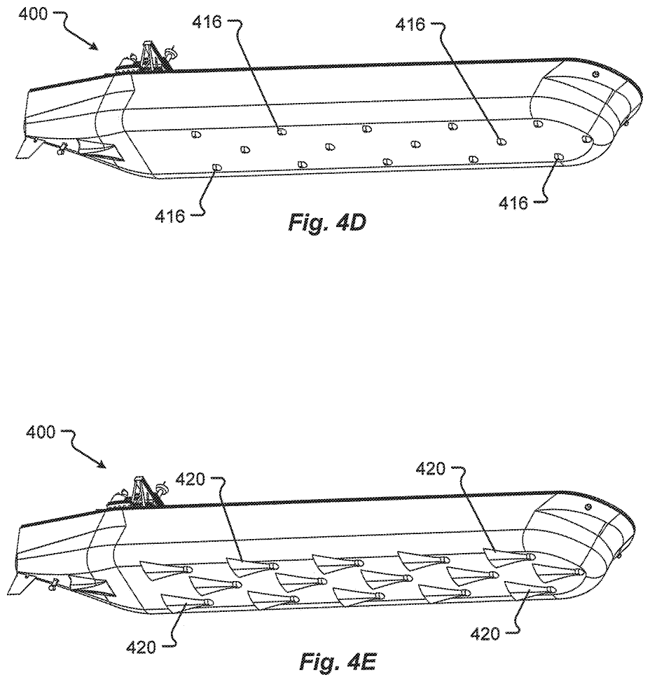

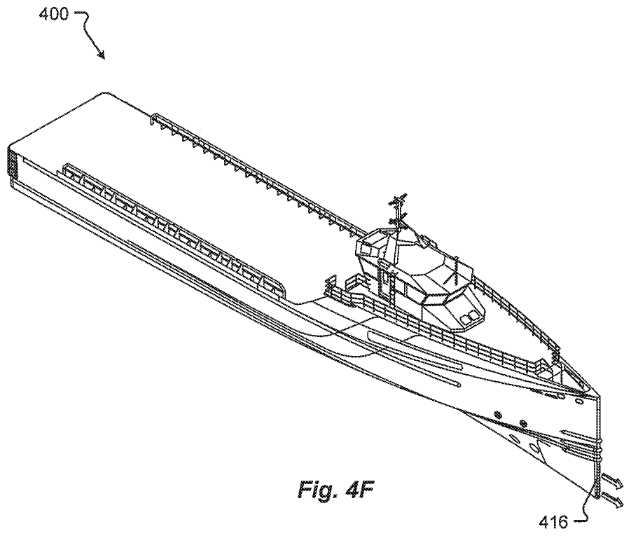

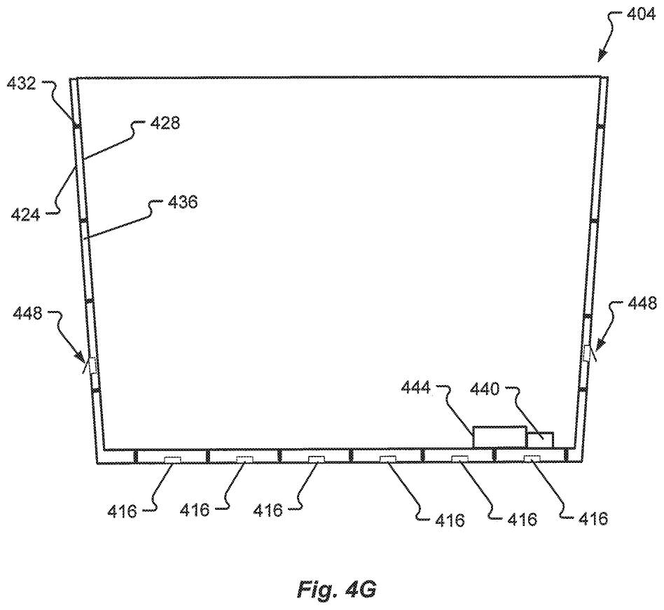

With reference now to FIGS. 4A-4G, another example of a vehicle 400 will be described in accordance with at least some embodiments of the present disclosure. The vehicle 400 is shown as a watercraft and, in particular, a shipping vessel, which may be configured for conveyance through a traveling medium of water. In the depicted embodiment, the vehicle 400 may include a body 404, a front end 408, and a propulsion unit 412. Although the vehicle 400 is depicted in FIGS. 4A-4E as a shipping vessel, it should be appreciated that the vehicle 400 may assume other formats such as shown in FIG. 4F. Indeed, any type of conveyance having a hull or the like may be considered a vehicle 400 without departing from the scope of the present disclosure.

The vehicle 400 is also shown to include one or more output ports 416 through which an expelled fluid 420 can be output. The expelled fluid 420 may be provided as a gas or liquid without departing from the scope of the present disclosure. Moreover, the number and placement of the various output ports 416 along the hull of the vehicle 400 may depend upon the hydrodynamic properties of the hull and which portions of the hull are considered to experience the most drag during operation. In some embodiments, as shown in FIGS. 4B-4E, the output ports 416 may be provided in an array across the bottom of the hull. As shown in FIG. 4F, one or more output ports 416 may be provided at a front end of the hull so as to provide the expelled fluid 420 across the solid surface of the vehicle 400 that would otherwise impact the traveling medium (e.g., water). In some embodiments, the expelled fluid 420 may be output at a volumetric rate that is substantially less than an amount of fluid displaced by the propulsion unit 412. As an example, the expelled fluid 420 may be output at a rate that is 10, 100, or 1000 times less than the rate at which fluid displaced by the propulsion unit 412. While the output rate of the expelled fluid 420 may not be significant enough to provide a substantial backwards force on the vehicle 400, the expelled fluid 420 may create a barrier between the solid surface of the vehicle 400 and the traveling medium, thereby breaking the inertial forces that would otherwise occur between the solid surface of the vehicle and the traveling medium.

As can be seen in FIG. 4G, the manner in which expelled fluid 420 is delivered to the various output ports 416 may vary depending upon the design of the vehicle 400 and the vehicle's 400 hull. In some embodiments, the body 404 or hull of the vehicle 400 may include an inner portion 428 and an outer portion 424 that are separated by a fluidic cavity 436 and a plurality of spacers 432. The plurality of spacers 432 may correspond to solid rods or disks that provide a predetermined spacing distance between the inner portion 428 of the hull and the outer portion 424 of the hull. The gap created between the inner portion 428 and outer portion 424 may correspond to a cavity that receives and stores fluid that is eventually output via the output ports 416.

In some embodiments, the fluidic cavity 436 may have the fluid therein compressed to a pressure that is greater than the pressure existing at the outside of the outer portion 424. The fluid within the fluidic cavity 436 may be compressed with a compressor 444 (or pump/hydraulic pump) under control of a fluid output controller 440. Thus, as the vehicle 400 is traveling and the hull is submerged in the traveling medium, at least some traveling medium may enter the fluidic cavity 436. The fluidic cavity 436 may be substantially sealed from the inside of the hull such that the compressor 444 is able to impart an increased pressure into the fluidic cavity 436. The amount of pressure provided by the compressor 444 may be controlled by the fluid output controller 440 and may be based upon a desired flow rate of expelled fluid 420. Alternatively or additionally, one or more output ports 416 may be provided with a movable port door 448 that is capable of being actuated or controlled by the fluid output controller 440 in such a way that certain of the output ports 416 are used to release expelled fluid 420 from the fluidic cavity 436 at a certain point in time whereas others of the output ports 416 have their corresponding movable port door 448 closed, thereby not allowing expelled fluid 420 to exit via that output port 416. Thus, the fluid output controller 440 may be provided with logic and communication capabilities to control the operation of the movable port door(s) 448 in addition to or in lieu of controlling operation of the compressor 444. Alternatively or additionally, the controller 440 could be configured to control operation of one or more flow valves that sit between a fluid container and the output ports 416. In this way, the fluid output controller 440 may adjust the behavior of the output ports 416 and/or the rate at which expelled fluid 420 is discharged from the output ports 416. This control may be achieved mechanically, via control of fluid control valves, and/or via pressurization of the fluidic cavity 436.

In other embodiments, rather than relying upon an improved hull design, the vehicle 400 may be provided with a simple compressed fluid tank and one or more hoses and fluid couplings may be connected between the compressed fluid tank and the output ports 416. In such a configuration, the fluid output controller 440 may control the amount of fluid provided to any one individual output port 416 from the compressed fluid tank, thereby controlling the flow rate of the expelled fluid 420.

It should be appreciated that the placement and/or design of the output ports 416 may vary depending upon the shape of the vehicle 400 and the desired dynamic properties of the output ports 416. In some embodiments, the shape/size of the output ports 416 may be relatively simple (e.g., circular shaped holes with or without one or more adjustable covers that slide directly over the hole, but are otherwise substantially flush with the outer portion 424 of the hull) or more complex (e.g., non-circular shaped openings with a movable port door 448 that moves along a hinge rather than sliding over the opening). Alternative configurations of output ports 416 and port doors 448 may also be used without departing from the scope of the present disclosure.

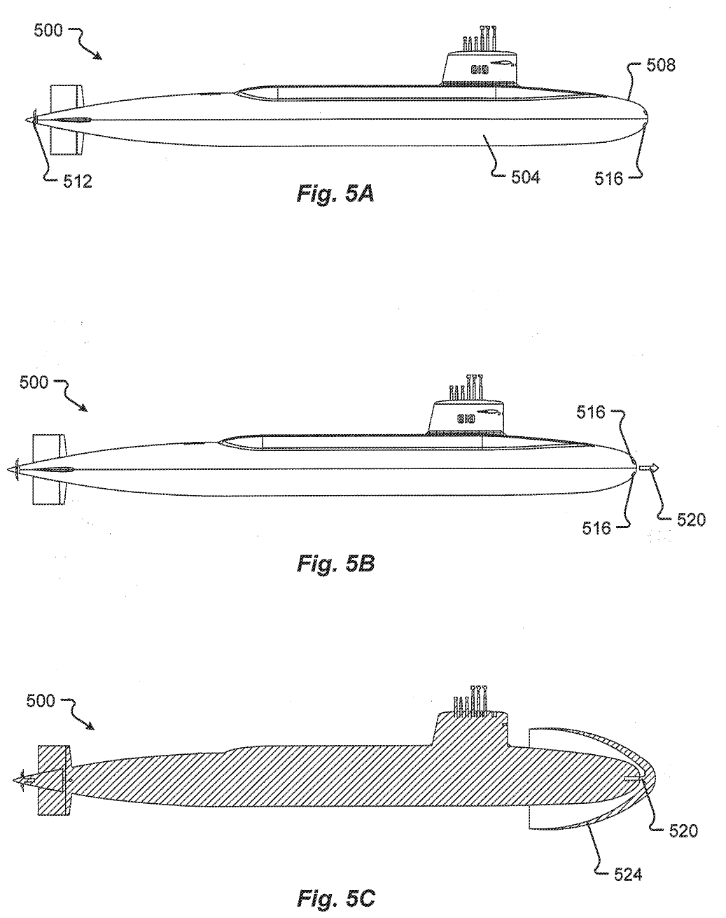

As can be seen in FIGS. 5A-5C, the vehicle 500 may alternatively be provided as a fully-submersible vehicle 500. The vehicle 500 may still include a body 504, a front end 508, and a propulsion unit 512, similar to vehicle 400; however, the vehicle 500 may be configured for complete submersion in a traveling medium (e.g., water). This particular design of a vehicle 500 may include one or more output ports 516 at the front end 508 that discharge expelled fluid 520. Again, the expelled fluid 520 may be provided by an internal fluid tank that is maintained in the body 504 and that compresses the fluid to a pressure greater than the pressure existing at the outside of the body 504. Because the vehicle 500 is capable of diving to various depths, the compressor used to compress the fluid that is eventually provided as the expelled fluid 520 may be configured to dynamically adjust the pressure with which the expelled fluid 520 is compressed. In some embodiments, the compression provided to the expelled fluid 520 should be adjustable based on the dive depth of the vehicle 500.

As shown in FIG. 5C, the expelled fluid 520 may travel along a fluid path 524 that substantially envelopes or wraps around the front end 508 of the vehicle 500. The fluid path 524 travelled by the expelled fluid 520 may cause the traveling medium that is substantially still relative to the traveling vehicle 500 to be broken or broken prior to impacting the solid surface of the vehicle 500. This effectively helps reduce drag forces presented to the vehicle 500, thereby reducing the amount of fuel required to drive the propulsion unit(s) 512. Although the vehicle 500 is shown as having four (4) output ports 516, it should be appreciated that the vehicle 500 may have a greater or lesser number of output ports 516 without departing from the scope of the present disclosure. Furthermore, the shape and placement of the output ports 516 may vary depending upon the shape of the body 504 and/or front end 508.

It should be appreciated that the vehicles 400, 500 (or any other vehicle depicted and described herein) may utilize expelled fluid as a propulsion mechanism in lieu of or in addition to utilize the expelled fluid to create a barrier between the solid surface(s) of the vehicle and the traveling medium. For instance, with respect to a ship's hull, the expelled fluid could be leveraged to reduce drag as described herein in addition to or in lieu of providing a separate propulsion system. The expelled fluid may also be used to control steering of the vehicle without departing from the scope of the present disclosure.

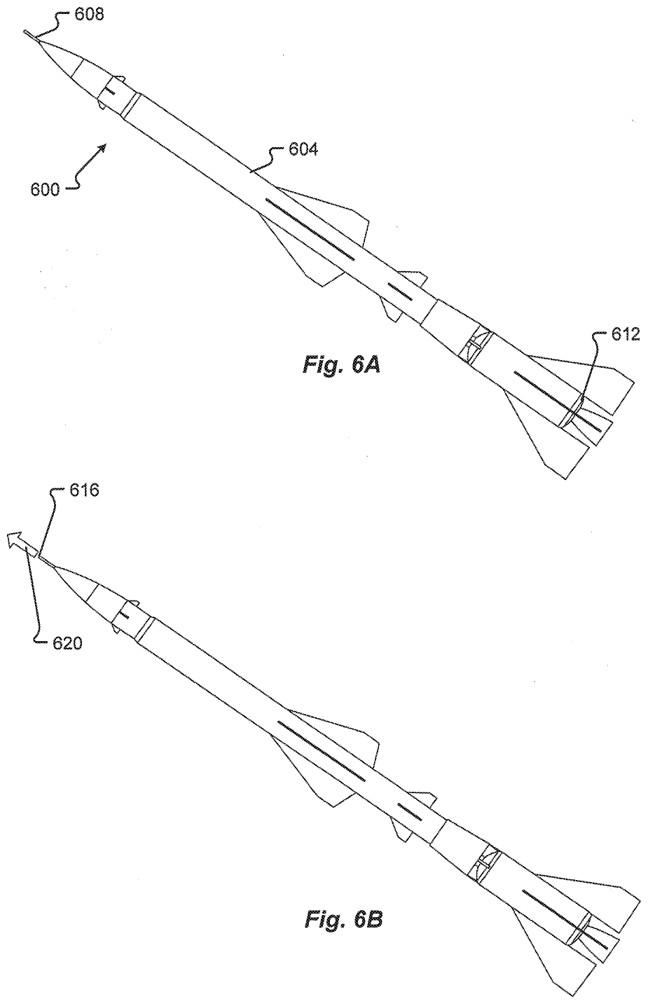

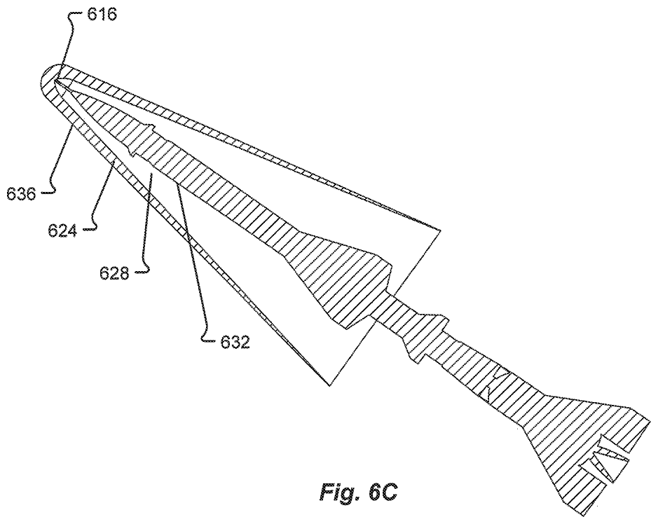

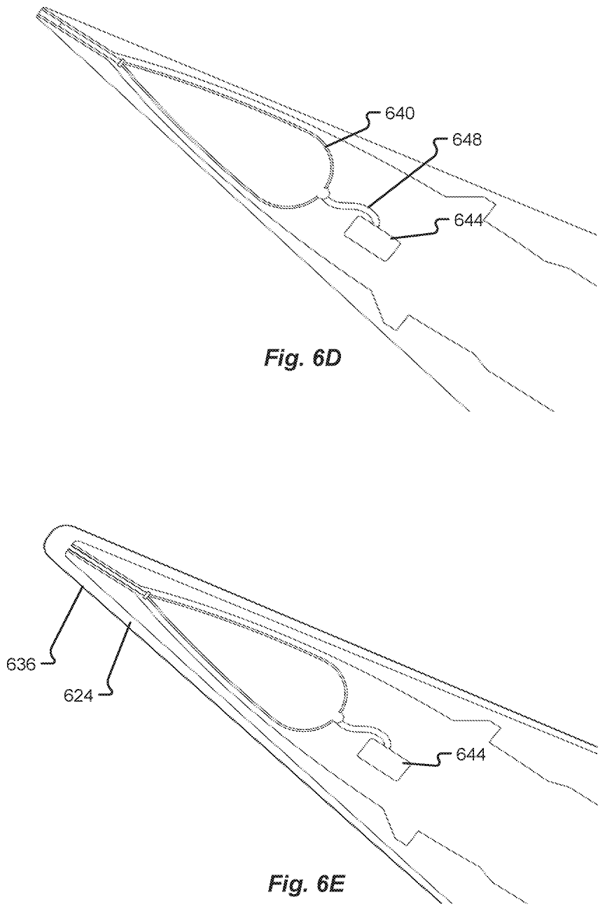

With reference now to FIGS. 6A-6E, additional details of another vehicle 600 will be described in accordance with at least some embodiments of the present disclosure. The vehicle 600 corresponds to another example of an object configured to travel through air as a traveling medium. The vehicle 600 is shown to include a body 604, a front end 608, and a propulsion unit 612. Furthermore, like other vehicles depicted and described herein, the vehicle 600 may be configured with one or more output ports 616 through which an expelled fluid 620 can be dispensed. Specifically, in some embodiments, the expelled fluid 620 may be dispensed while the vehicle 600 is in motion through a traveling medium.

The rate at which expelled fluid 620 is dispensed may be controlled by a controller 644 that is integrated into the body 604 of the vehicle 600. The controller 644, as with other controllers depicted and described herein, may be configured to control an amount and/or rate with which fluid is dispensed from a fluid container 640 via a control line 648. In some embodiments, the fluid container 640 may be filled with a fluid prior to departure of the vehicle and once the entirety of the fluid is dispensed as expelled fluid 620, then no more fluid may be dispensed (e.g., because the fluid container 640 is empty). In other embodiments, motion of the vehicle 600 may cause the fluid container 640 to be refilled with surrounding fluid (e.g., fluid recaptured from motion of the vehicle 600 through the traveling medium). In such a situation, the controller 644 may also control a compressor or pump that causes a pressure within the fluid container 640 to be increased and enables the expelled fluid 620 to release from the output port 616 at a controlled rate.

FIG. 6C shows additional details of the fluid path 624 that may be travelled by the expelled fluid 620. In particular, the expelled fluid 620 may travel a fluid path 624 that includes a first interaction area 628 and a second interaction area 636 in addition to the main channel of the fluid path 624. The main channel of the fluid path 624 may correspond to the volume of expelled fluid that travels between the first interaction area 628 and the second interaction area 636. In some embodiments, the first interaction area 628 may correspond to a surface area with which the expelled fluid 620 interacts with the body surface 632 of the vehicle 600, which may correspond to a solid surface. This first interaction area 628 may create a first drag force that is imparted on the vehicle 600 traveling through the traveling medium (e.g., the atmosphere). The second interaction area 632 may correspond to a surface area with which the expelled fluid 620 interacts with the traveling medium. It is this second interaction area 636 that enables the expelled fluid 620 to break the inertia of the traveling medium before the solid body surface 632 comes into contact with the traveling medium. There may also be drag forces present at the second interaction area 636 between the expelled fluid 620 and the traveling medium. The sum of the drag forces at the first interaction area 628 and second interaction area 636 may be less (and possibly substantially less (e.g., up to 25% or more) than the drag forces that would otherwise be exerted on the body surface 632 in the absence of the expelled fluid 620 being dispensed from the output port 616. Again, the backward force exerted on the vehicle 600 due to the dispensing of the expelled fluid 620 from the output port 616 may be nominal or negligible as compared to the reduced drag forces. Overall, the utilization of the expelled fluid 620 may help to reduce the overall drag forces presented to the vehicle 600 traveling through the traveling medium.

In some embodiments, the controller 644 may be provided with logic that is capable of determining an altitude, speed, acceleration, or other ballistic property of the vehicle 600 and, in response thereto, may adjust the amount or rate with which the expelled fluid 620 is dispensed from the output port 616. The controller 644 may also be configured to discontinue dispensing fluid from the fluid container 640 under predetermined conditions (e.g., during initial takeoff or after the vehicle 600 has reached a predetermined altitude or is out of the atmosphere).

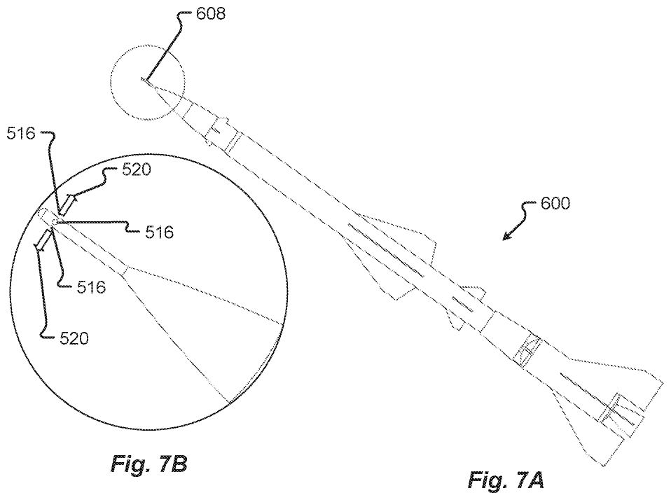

As can be seen in FIGS. 7A and 7B, the vehicle 600 may be provided with one or more output ports 516 that are positioned at the front end 608 of the vehicle 600, but are provided with an orientation that is substantially perpendicular to the direction of travel of the vehicle 600. In some embodiments, the output ports 516 may be provided in an array around the front end 608 such that a plurality of output ports 516 can provide expelled fluid 520 in multiple directions that are orthogonal to the direction of travel. As can be seen in detail of FIG. 7B, a pair of output ports 516 may be provided in directly opposite facing orientations such that any amount of expelled fluid 520 provided out of one output port 516 is substantially matched with an equal amount of expelled fluid 520 (e.g., equal in volume and flow rate) so as to counteract any orthogonal forces exerted on the vehicle 600. In other words, the pair of output ports 516 may be configured to output expelled fluid 520 at substantially the same time, at substantially the same rate, at substantially the same pressure, and at substantially the same volume so that the net forces exerted in the opposite direction of the pair of ports 516 are cancelled out. In some embodiments, the pair of ports 516 may be provided with a first orientation (e.g., vertically facing upwards) and a second, opposite, orientation (e.g., vertically facing downwards). Additional or other pairs of ports 516 may also be provided (e.g., facing outward on the port and starboard sides of the vehicle) so as to enable the expelled fluid 520 to be provided outward to the left and right of the vehicle 600.

In some embodiments, the front end 608 of the vehicle 600 may be provided with just two output ports 516 (e.g., one facing in one direction that is orthogonal to the direction of travel and another facing opposite to the first output port). Alternatively, the vehicle 600 may be provided with two, three, four, or more pairs of output ports 516 facing in many different directions, where each pair of output ports 516 are configured to output the expelled fluid 520, but in a way that no substantial steering forces are imparted on the vehicle 600 (unless the fluid 520 is desired to provide some steering forces). If steering is desired by using the expelled fluid 520, then it may be possible to, in a controlled manner, provide more expelled fluid 520 from one of the output ports 516 than the other of the output ports 516 that is facing in the opposite direction. This may result in a lateral force being exerted on the vehicle 600, but the amount of force exerted may depend upon the amount of expelled fluid 520, its flow rate, etc.

It should be appreciated that by using the output ports 516 as shown in FIGS. 7A and 7B, it may be possible to achieve the benefits associated with breaking the drag forces that could be exerted on the vehicle 600 by the traveling medium, but without providing a backwards force due to the expelled fluid 520 being expelled directly in the direction of travel. In some embodiments, it may be possible to configure the output ports 516 to control a direction and amount of expelled fluid 520. Thus, a single output port 516 may be configured to adjust a direction with which expelled fluid 520 is discharged (e.g., change between a direction of flow that has some component in the direction of travel and some component that is orthogonal to the direction of travel). With this type of output port 516, additional steering capabilities can be realized for the vehicle 600 in addition to helping reduce the drag imparted on the vehicle traveling through the traveling medium.

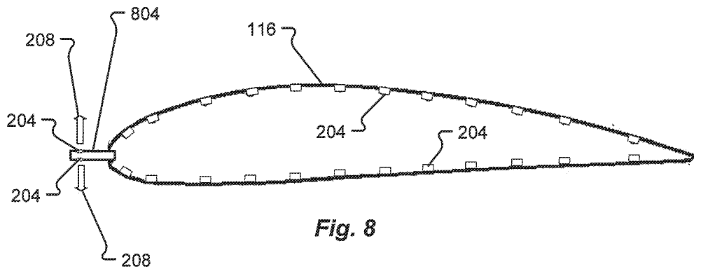

FIG. 8 depicts a similar concept, but for a wing 116 as opposed to the vehicle 600 depicted in FIGS. 7A and 7B. As shown in FIG. 8, the wing 116 may be provided with a plurality of output ports 204 across the cross-section of the airfoil. The output ports 204 may be provided in vertical pairs such that fluid expelled 208 from one output port 204 is counteracted by expelled fluid 208 from the other output ports 204 in the pair. Again, providing the output ports 204 in pairs may enable the airfoil to experience a decreased drag during travel through air, but without imparting unwanted upward or downward force on the wing 116. However, as discussed above, it may be possible to precisely control aspects of lift on the wing 116 by providing more expelled fluid 204 from one output port 204 than the other, oppositely-oriented, output port 204.

FIG. 8 also shows that the wing 116 may be fitted with one or more forward-facing nozzles 804 that are provided with one or more output ports 204 thereon. This nozzle 804 may have a similar configuration to the needles or nozzles shown in other vehicles (e.g., vehicle 600). For instance, the output ports 204 provided on the forward-facing nozzle 804 may be configured to dispense the expelled fluid 208 outward from the circumference of the nozzle 804 in a direction that at least has some component that is orthogonal to the direction of travel. Again, the output ports 204 provided on the nozzle 804 may be provided in one or more pairs to help maintain symmetry.

It should be appreciated that while pairs of output ports have been described herein, that similar functional goals can be achieved by an odd number of output ports that are symmetrically distributed around an object (e.g., wing 116, nozzle 804, etc.). The set of output ports (e.g., where the number of output ports is not necessarily even) may be configured to collectively cancel out each other's lateral forces, thereby providing a drag reducing function without necessarily impacting the direction of travel or lateral forces imparted on the vehicle. Of course, the expelled fluid 208 from the various output ports in the set of output ports could be controlled to not cancel out, but rather impart steering forces on the vehicle.

In some embodiments, the nozzle 804 may comprise a shared volume from which expelled fluid 208 is provided to both of the output ports 204. In other words, each output port 204 in the set of output ports on the nozzle 804 may receive their fluid from a common source, thereby helping to manage or control the amount/volume/rate with which the expelled fluid 208 is dispensed from each of the output ports 204.

Specific details were given in the description to provide a thorough understanding of the embodiments. However, it will be understood by one of ordinary skill in the art that the embodiments may be practiced without these specific details. Additionally, the Figures do not depict well-known features that may be needed to create a working vehicle so as not to obscure the embodiments in unnecessary detail.

What is claimed is:

1. A vehicle, comprising:
a solid surfaced body having a front end;
a propulsion unit that applies a propulsion force to the body and causes the front end to travel toward a traveling medium in a direction of travel; and
at least one output port that is positioned on the body in such a way that fluid expelled from the at least one output port is expelled in a direction opposite to the propulsion force, wherein the fluid expelled from the at least one output port is expelled at a rate that is at least one order of magnitude less than a rate at which fluid is displaced by the propulsion unit, and wherein the fluid expelled from the at least one output port impacts the traveling medium prior to the body thereby breaking inertial forces that would otherwise be applied to the body by the traveling medium.

2. The vehicle of claim 1, wherein the traveling medium comprises a gas.

3. The vehicle of claim 1, wherein the traveling medium comprises a liquid.

4. The vehicle of claim 1, wherein the at least one output port comprises a plurality of output ports.

5. The vehicle of claim 1, wherein the at least one output port comprises a moveable port door that is controlled by a controller.

6. The vehicle of claim 5, wherein the controller is contained within the body.

7. The vehicle of claim 5, wherein the controller further comprises logic to control a rate with which the fluid is expelled from the at least one output port.

8. The vehicle of claim 7, wherein the controller is connected with a compressor that adjusts a pressure of fluid in a fluid container to control the rate with which the fluid is expelled from the at least one output port.

9. The vehicle of claim 1, wherein the traveling medium is the same as the fluid expelled from the at least one output port.

10. The vehicle of claim 1, wherein the traveling medium is different from the fluid expelled from the at least one output port.

11. The vehicle of claim 1, wherein the fluid expelled from the at least one output port is expelled at a rate that is at least two orders of magnitude less than the rate with which fluid is displaced by the propulsion unit.

12. The vehicle of claim 1, wherein the propulsion unit comprises a jet engine.

13. The vehicle of claim 1, wherein the propulsion unit comprises a turbine or a propeller.

14. The vehicle of claim 1, wherein the propulsion unit comprises an internal combustion engine or electric motor that drives rotation of one or more wheels.

15. The vehicle of claim 1, wherein the traveling medium is contained in a tunnel and wherein the vehicle travels through the tunnel while the fluid is expelled from the one or more output ports.

16. A vehicle, comprising:
a solid surfaced body having a front end;
a propulsion unit that applies a propulsion force to the body and causes the front end to travel toward a traveling medium in a direction of travel; and
a set of output ports that are positioned on the body in such a way that fluid expelled from one output port from the set of output ports substantially cancels out later forces imparted on the vehicle by other output ports from the set of output ports, wherein the fluid expelled from the set of output ports is further configured to impact the traveling medium and break inertial forces that would otherwise be applied to the body by the traveling medium.

17. The vehicle of claim 16, wherein the set of output ports comprises an even number of output ports.

18. The vehicle of claim 16, wherein the set of output ports are provided on a nozzle and substantially circumnavigate the nozzle.

19. The vehicle of claim 16, wherein the set of output ports are provided on a wing.

20. A vehicle, comprising:
a solid surfaced body having a front end;
a propulsion unit that applies a propulsion force to the body and causes the front end to travel toward a traveling medium in a direction of travel; and
one or more output ports that are positioned on the body in such a way that fluid expelled thereby are able to break inertial forces that would otherwise be applied to the body by the traveling medium, wherein the fluid is expelled at a rate that is at least two orders of magnitude less than a rate at which fluid is displaced by the propulsion unit.
